(19) United States
(12) Patent Application Publication
(10) Pub. No.: US 2026/0309546 A1
(43) Pub. Date: Oct. 8, 2026

(54) NANO-SATELLITE ATMOSPHERIC CHEMISTRY HYPERSPECTRAL OBSERVATION SYSTEM

(71) Applicant: Triad National Security, LLC, Los Alamos, NM (US)

(72) Inventors: Steven Paul LOVE, Los Alamos, NM (US); Logan Ayres OTT, Los Alamos, NM (US); Magdalena Elizabeth DALE, Los Alamos, NM (US); James Patrick THEILER, Los Alamos, NM (US); Claira Lyrae SAFI, Los Alamos, NM (US); Kerry Gardiner BOYD, Los Alamos, NM (US); Hannah Dornath MOHR, Los Alamos, NM (US)

(21) Appl. No.: 19/090,979

(22) Filed: Mar. 26, 2025

Related U.S. Application Data
(60) Provisional application No. 63/575,215, filed on Apr. 5, 2024.

(51) Int. Cl. G01J 3/28; B64G 1/10; G01J 3/02

(52) U.S. Cl. CPC G01J 3/2823; B64G 1/1021; G01J 3/0202; G01J 3/0208; G01J 3/021; G01J 3/0256; G01J 3/0286; G01J 3/0291; G01J 3/0297; G01J 2003/283

(57) ABSTRACT

A hyperspectral imaging system is provided. In an example embodiment, the system includes an objective configured to focus light on a slit; the slit; a spectrometer assembly configured to spectrally disperse the light received via the slit; a detector, wherein the spectrometer assembly focuses the spectrally dispersed light onto the detector and the detector captures hyperspectral imaging data; and a memory configured to store the hyperspectral imaging data. The spectrometer assembly comprises an optical bench and a plurality of optical elements that are each formed of a common material such that the optical bench and the plurality of optical elements have a same thermal coefficient of expansion.

### CROSS-REFERENCE TO RELATED APPLICATION(S)

This application claims priority to U.S. Application No. 63/575,215, filed Apr. 5, 2024, the content of which is incorporated herein by reference in its entirety.

### FEDERALLY SPONSORED RESEARCH OR DEVELOPMENT

This invention was made with government support under 89233218CNA000001 awarded by the U.S. Department of Energy. The government has certain rights in the invention.

### TECHNOLOGICAL FIELD

An example embodiment relates to an atmospheric chemistry hyperspectral observation system that may be implemented in a mobile manner. For example, an example embodiment relates to an atmospheric chemistry hyperspectral observation system that is space-deployable on a CubeSat.

### BACKGROUND

Our planet's atmosphere is composed primarily of nitrogen and oxygen, but also contains a number of less abundant and potentially harmful gases that affect the planet's health and habitability. Carbon dioxide, methane, and ozone are a few familiar examples of the less abundant gasses that contribute to our planet's atmosphere. Ozone (O₃) protects us from harmful ultraviolet (UV) radiation when it occurs high in the stratosphere but is a dangerous toxic pollutant when it occurs at ground level. Other less abundant trace gases play an outsized role in affecting human heath, agricultural and forest productivity, and the overall sustainability of the natural environment. Nitrogen dioxide (NO₂), for instance, is produced in internal combustion engines and fossil-fuel-burning power plants, followed by a complex and still poorly understood set of chemical reactions with atmospheric oxygen, ozone, and sunlight. It is, along with ozone, responsible for the bulk of urban air pollution. Chronic exposure to NO₂ at levels typical of today's large, polluted cities, can lead to respiratory diseases such as asthma and chronic obstructive pulmonary disease (COPD), cardiovascular disease, and even reproductive and developmental disorders. Sulfur dioxide (SO₂) is another example trace gas. Produced both naturally from volcanoes, and artificially, e.g., by burning sulfur-rich coal, SO₂ is another toxic pollutant of significant concern to human health and the major contributor to forest-and crop-damaging acid rain. Various other trace gases provide various human health and environmental concerns.

Trace gases are also indicators of distinct activities. For example, NO₂ is a powerful and easily detected indicator of fossil fuel burning. In addition, numerous volcanic gases aside from SO₂ help geologists understand deep-earth processes and help predict eruptions. Detecting tropospheric ozone or the toxic chemical formaldehyde produced by wildfires is also of great interest due to their harmful effects.

While ground-based measurements using a variety of direct-sampling point sensors can shed some light on these measurements, the distribution of important trace gases is so widespread and variable that airborne and preferably space-based remote sensing approaches offer an option for obtaining accurate information. However, the most powerful remote sensing options having sufficient spectral resolution and sensitivity for trace gas imaging have been expensive, complex, heavy, and power-hungry, and have required extremely expensive large-satellite platforms and dedicated rocket launches for space deployment. Through applied effort, ingenuity, and innovation many deficiencies of such prior systems have been solved by developing solutions that are structured in accordance with the embodiments of the present invention, many examples of which are described in detail herein.

### BRIEF SUMMARY OF SOME EXAMPLE EMBODIMENTS

Various embodiments provide systems and corresponding methods for mobile and/or space-deployed detection and/or measurement of atmospheric trace gases. For example, various embodiments provide a hyperspectral imaging system configured for detecting and/or measuring atmospheric trace gases and methods corresponding thereto. In an example embodiment, the hyperspectral imaging system is configured to be space-deployed. For example, the hyperspectral imaging system may be hosted by a CubeSat or other small satellite vehicle.

According to one aspect, a hyperspectral imaging system is provided. The system includes an objective; and a slit, the objective configured to focus light on the slit. The system further includes a spectrometer assembly configured to spectrally disperse the light received via the slit; a detector, wherein the spectrometer assembly focuses the spectrally dispersed light onto the detector and the detector captures hyperspectral imaging data; and a memory configured to store the hyperspectral imaging data. The spectrometer assembly comprises an optical bench and a plurality of optical elements that are each formed of a common material such that the optical bench and the plurality of optical elements have a same thermal coefficient of expansion.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a schematic diagram of a system for including a hyperspectral imaging system deployed on a satellite, in accordance with an example embodiment;

FIG. 2 is a block diagram of an example hyperspectral imaging system, in accordance with an example embodiment;

FIG. 3 is a schematic diagram illustrating an example imaging system, in accordance with an example embodiment;

FIG. 3A illustrates an example spectrometer assembly and provides a schematic of the spectrally dispersed light incident on the imaging plane of the detector, in accordance with an example embodiment;

FIG. 4 is a cross-sectional view of an objective and the objective mounting assembly, in accordance with an example embodiment;

FIG. 5A provides an expanded view of a mirror mounting assembly, in accordance with an example embodiment;

FIG. 5B provides a top view of an example mirror showing the flexures formed for securing the mirror to the mirror mounting assembly, in accordance with an example embodiment;

FIGS. 6A and 6B each provide a cross-sectional view of respective surface treatments used in an example embodiment;

FIG. 7 provides a perspective view of a housing of a hyperspectral imaging system, in accordance with an example embodiment;

FIG. 8 is a flowchart illustrating an example method for using a hyperspectral imaging system to detect trace gases, in accordance with an example embodiment; and

FIG. 9 provides a block diagram of an example ground-based system that may be used in accordance with an example embodiment.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide systems and corresponding methods for mobile and/or space-deployed detection and/or measurement of atmospheric trace gases. For example, various embodiments provide a hyperspectral imaging system configured for detecting and/or measuring atmospheric trace gases and methods corresponding thereto. In an example embodiment, the hyperspectral imaging system is configured to be space-deployed. For example, the hyperspectral imaging system may be hosted by a CubeSat or other small satellite vehicle. Thus, various embodiments provide a miniaturized hyperspectral imaging system (e.g., having dimensions of only a few centimeters).

In an example embodiment, the hyperspectral imaging system includes an objective, a slit that the objective is configured to focus light onto, a spectrometer assembly configured to spectrally disperse light received thereby via the slit, and a detector. The spectrometer assembly is configured to focus the spectrally dispersed light onto the detector (e.g., an imaging plane thereof). The detector captures hyperspectral imaging data that encodes hyperspectral information regarding the spectrally dispersed light that is incident on the detector. The spectrometer assembly comprises an optical bench and a plurality of optical elements that are formed of a common material such that the optical bench and the plurality of optical elements have a common thermal expansion coefficient.

In various embodiments, some of the optical elements of the spectrometer assembly have fixed positions and/or orientations while other of the optical elements are mounted to the optical bench via alignment adjustment components. In various embodiments, each of the alignment adjustment components is associated with a locking component configured to lock the alignment adjustment components such that the corresponding optical elements have selectively fixed positions and/or orientations. For example, the optical elements of the spectrometer are mounted so as to prevent the optical elements from becoming misaligned during launching of a satellite housing the hyperspectral imaging system, in an example embodiment. For example, in various embodiments, at least some of the optical elements of the spectrometer are mounted using a zero-backlash mounting system. In an example embodiment, at least some of the optical elements of the spectrometer are mounted using flexures configured to mechanically isolate the optical surface of the optical elements from the portion of the optical element used to mount the optical element to a corresponding mount.

In various embodiments, the hyperspectral imaging system is configured to passively perform heat management. For example, the optical elements and the housing of the spectrometer are formed of a common material such that they have a common thermal expansion coefficient. In another example, the objective mounting assembly includes a first mounting tube and a second mounting tube that are each made of different materials. The materials of the mounting tubes are selected to have coefficients of thermal expansion such that as the objective experiences a temperature change, the change in distance between the slit and the objective changes such that the changing focal distance of the objective maintains the objective being focused on the slit. In another example, the detector is passively cooled using the housing of the hyperspectral imaging system and/or the body of the satellite as a heat sink. For example, the detector is in thermal communication with housing of the hyperspectral imaging system and/or the body of the satellite.

In various embodiments, the hyperspectral imaging system includes a calibration system. In various embodiments, the calibration system is a static or stationary calibration system. For example, the calibration system does not include any moving parts, in an example embodiment. In an example embodiment, the calibration system includes one or more calibration system illumination sources that are configured to uniformly illuminate the detector such that non-uniformity effects of the detector may be calibrated and/or corrected.

In various embodiments, the hyperspectral imaging system includes one or more processing elements configured to perform onboard processing of the raw hyperspectral data generated by the spectrally dispersed light being incident on the detector. For example, the one or more processing elements may determine a respective detection map for one or more gas species of interest from the raw hyperspectral data through the use of an adaptive match filter algorithm. For example, the one or more processing elements may be configured to perform onboard processing of the raw hyperspectral data such that the results of performing a scan using the hyperspectral imaging system may be transmitted via the limited telemetry bandwidth available to satellite systems.

Measuring the distribution of various trace gases may be performed for a variety of reasons, such as environmental monitoring, activity monitoring, etc. While ground-based measurements using a variety of direct-sampling point sensors can shed some line on the presence and/or abundance of trace gases, the distribution of various trace gases is so widespread and variable that airborne and space-based remote sensing approaches provide a more reliable strategy for obtaining accurate information. However, conventional space-based sensors of sufficient spectral resolution and sensitivity for trace gas imaging tend to be expensive, complex, heavy, and power-hungry systems that require very expensive large satellite platforms and dedicated launches for space deployment. However, reducing the size and power requirements of such systems is not straight forward and leads to multiple technical challenges, including maintaining optical alignment and focus of the system despite mechanical stress experienced during launch events and changing temperature conditions experienced over the course of an orbit. Moreover, due to the small size and reduced power requirements, conventional calibration systems do not provide adequate reliability. Therefore, additional technical challenges exist regarding how to calibrate such a system.

Further complications for space-based remote sensing approaches include the limited telemetry bandwidth available for transmitting captured HSI data to ground-based systems. For example, the size of a raw HSI datacube for a single scan may be on the order of 400 Megabytes. However, onboard processing of the raw HSI datacube to reduce the amount of data to be downlinked to ground-based systems using conventional data processing algorithms requires several hours of computational activities.

Therefore, technical problems exist regarding imaging systems that may be used for mobile and/or space-based monitoring of trace gases.

Various embodiments provide technical solutions to these technical challenges. For example, various embodiments provide a hyperspectral imaging (HSI) system configured for mobile and/or space-based use. HSI is a form of spectral imaging where, instead of three spectral bands of a color image, a high-resolution including tens or hundreds of independently measured wavelength bands are captured. In various embodiments, the HSI system is configured for deployment on a small satellite, such as a CubeSat.

In various embodiments, the size, weight, and power-requirements of the HSI system are configured for deployment on a small satellite. For example, the optical path of the spectrometer assembly of the HSI system is folded so as to cause the HSI system to fit in a 1U space (e.g., a 10 cm by 10 cm by 10 cm cube). Moreover, the power requirements of the HSI system are low in part because the HSI system uses passive (zero-power-consumption) thermal management to meet the detector array and support electronics needs. Moreover, the spectrometer assembly comprises an optical bench and a plurality of optical elements that are formed of a common material such that the optical bench and the plurality of optical elements have a common thermal expansion coefficient. Additionally, the objective mounting assembly is configured to passively adjust to accommodate changes in the focal length of the objective due to changing temperatures. Thus, the HSI system has sufficient thermal stability for space-based operation.

Additionally, in various embodiments, some of the optical elements of the spectrometer assembly have fixed positions and/or orientations while other of the optical elements are mounted to the optical bench via alignment adjustment components. In various embodiments, each of the alignment adjustment components is associated with a locking component configured to lock the alignment adjustment components such that the corresponding optical elements have selectively fixed positions and/or orientations. This enables the HSI system to maintain optical alignment even after experiencing the extreme forces and turbulence of space launch.

In various embodiments, the hyperspectral imaging system includes one or more processing elements configured to perform onboard processing of the raw hyperspectral data to generate detection maps on the order of 1 Megabyte in size for each of one or more gases of interest. In some embodiments, a Mahalanobis distance image is also generated using approximations that reduce onboard processing time from several hours to about ten minutes while having a negligible effect on the accuracy of the results. For example, the one or more processing elements may be configured to perform onboard processing of the raw hyperspectral data such that the results of performing a scan using the hyperspectral imaging system may be transmitted via the limited telemetry bandwidth available to satellite systems without requiring significant amounts of power to perform the onboard processing.

Various embodiments provide additional other technical improvements over conventional space-based HSI systems. For example, in various embodiments, the hyperspectral imaging system includes a calibration system that does not include any moving parts. In an example embodiment, the calibration system includes one or more calibration system illumination sources (e.g., light emitting diodes (LEDs)) that are configured to uniformly illuminate the detector such that non-uniformity effects of the detector may be calibrated and/or corrected.

Thus, various embodiments provide technical solutions and improvements to the fields of trace gas detection and monitoring and space-based hyperspectral imaging.

### II. Example Architecture

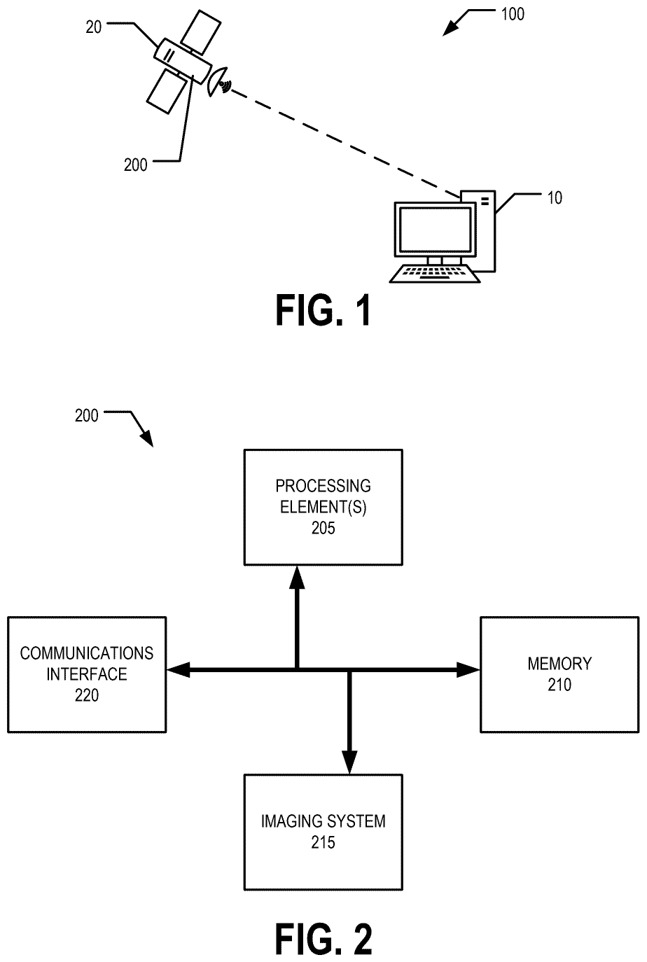

FIG. 1 provides an illustration of an example system 100, in accordance with an example embodiment. As shown in FIG. 1, the system 100 includes an HSI system 200 that is onboard a satellite vehicle 20. In various embodiments, the satellite vehicle 20 is a small satellite vehicle, such as a CubeSat. The system 100 further includes a ground-based system 10. In various embodiments, the ground-based system 10 and the HSI system 200 are in wireless communication with one another.

In various embodiments, the ground-based system 10 may provide one or more instructions to the HSI system 200 and/or the satellite vehicle 20. For example, the ground-based system 10 may provide instructions as to an area to be scanned with the HSI system 200, one or more scan parameters to be used when performing a scan, and/or the like. The HSI system 200 and/or the satellite vehicle 20 may receive the instructions and cause the satellite vehicle 20 to be pointed such that a scan of the indicated area may be performed with the indicated one or more scan parameters, and/or the like. In various embodiments, the HSI system 200 is configured to transmit and/or downlink spectral and/or detection data for receipt by the ground-based system 10. For example, the HSI system 200 may transmit and/or downlink raw HSI datacubes and/or pre-processed data, such as detection maps, for receipt by the ground-based system 10.

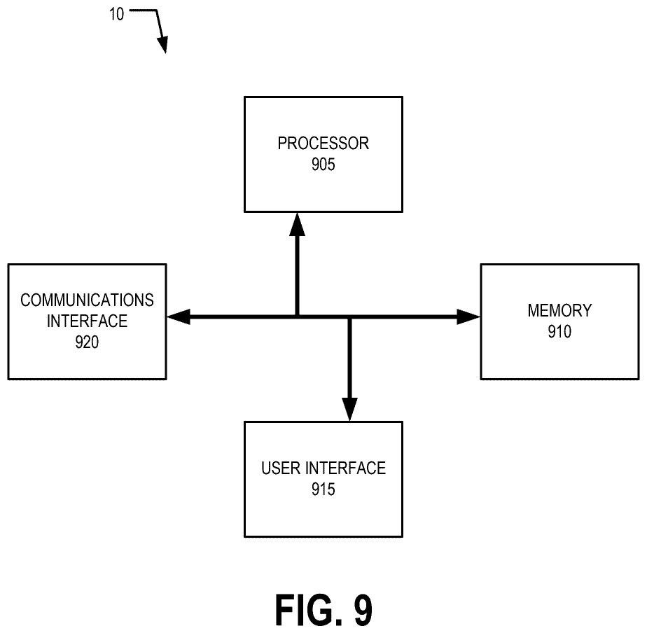

In various embodiments, the ground-based system 10 includes a computing entity such as a server, desktop computer, laptop, tablet, smartphone, and/or the like. For example, as shown in FIG. 9, in various embodiments, the ground-based system 10 includes one or more processors 905, one or more (non-transitory) memories 910, one or more user interfaces (e.g., display, speaker, keyboard, mouse, microphone, touchscreen, and/or the like), and one or more communications interfaces 920. Certain example embodiments of the ground-based system 10 are described in more detail below with respect to FIG. 9.

### III. Example Hyperspectral Imaging (HSI) System

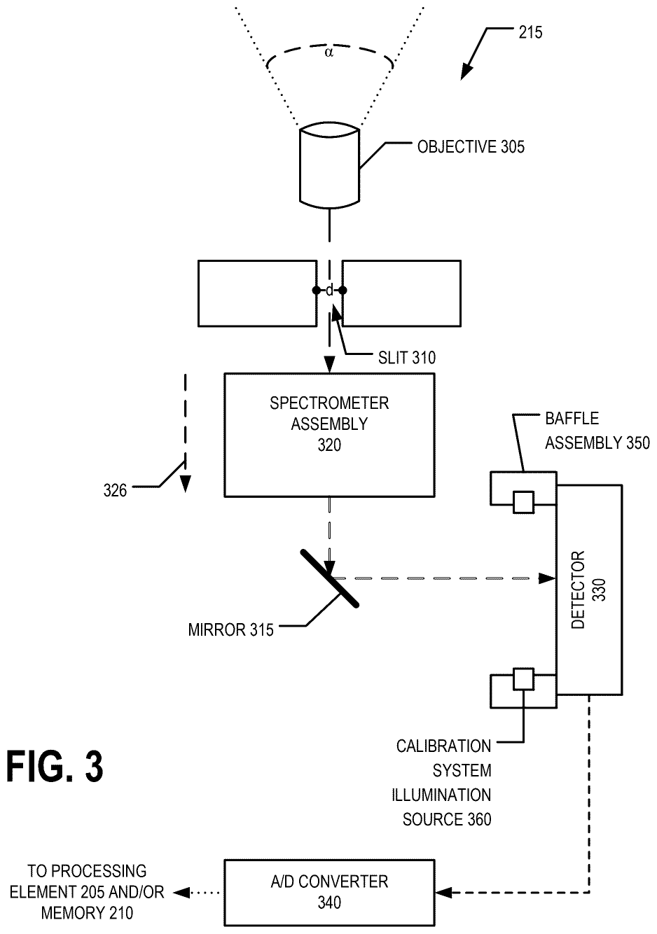

FIG. 2 provides a block diagram of an example HSI system 200, according to an example embodiment. In various embodiments, the HSI system 200 includes one or more processing elements 205, one or more memories 210, the imaging system 215, and a communications interface 220. For example, the communications interface 220 may be configured for communicating with the ground-based system 10 and/or one or more other satellite systems using one or more wireless communication protocols.

In some embodiments, the processing element(s) 205 may be in communication with the memory 210 via a bus for passing information among components of the HSI system 200. The memory 210 may include a non-transitory memory device. The memory 210 may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processing element(s)). The memory device may be configured to store information, data, content, applications, instructions, or the like for enabling the HSI system 200 to carry out various functions in accordance with an example embodiment of the present invention. For example, the memory device could be configured to buffer input data for processing by the processing element(s). Additionally or alternatively, the memory device could be configured to store instructions for execution by the processor.

For example, in various embodiments, the memory 210 stores a plurality of spectral data objects. In an example embodiment, a spectral data object provides the spectrum of a gas of interest in arbitrary units. For example, a spectral data object corresponding to a particular gas of interest provides an indication of in which spectral bins the spectrum of the particular gas of interest has spikes (e.g., emission features) and in which spectral bins the spectrum of the particular gas of interest has valleys (e.g., absorption features). For example, the spectral data object provides a model of the “spectral fingerprint” of the corresponding particular gas of interest.

In another example, in various embodiments, the memory 210 is configured to store a HSI datacube generated by performing a scan of an area. For example, as the HSI system 200 performs a scan, the HSI data generated is stored in the memory 210 for later processing, in various embodiments. In an example embodiment, the memory 210 is configured for storing results of processing the HSI data (e.g., detection maps, Mahalanobis distance image, and/or other data processing results) such that the communications interface 220 can transmit the results of processing the HSI data for receipt by the ground-based system 10 at an appropriate time.

In another example, the memory 210 stores computer-executable instructions that, when executed by the processing element(s) 205, causes the HSI system to process the HSI data to generate one or more detection maps, Mahalanobis distance images, and/or other data processing results.

In some embodiments, the support electronics of the HSI system 200 (e.g., processing element(s) 205, memory 210, communications interface 220, and/or the like) may be embodied as a chip or chip set. In other words, the HSI system 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The HSI system 200 may therefore, in some cases, be configured to implement the support electronics of an embodiment of the present invention on a single chip or as a single “system on a chip.” As such, in some cases, a chip or chipset may constitute means for performing one or more operations for providing the functionalities described herein.

The processing elements 205 may be embodied in a number of different ways. For example, the processing elements 205 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing element(s) 205 may include one or more processing cores configured to perform independently. A multi-core processor may enable multiprocessing within a single physical package. Additionally or alternatively, the processing element(s) 205 may include one or more processors configured in tandem via the bus to enable independent execution of instructions, pipelining and/or multithreading.

In an example embodiment, the processing element(s) 205 may be configured to execute instructions stored in the memory 210 or otherwise accessible to the processing element(s). Alternatively or additionally, the processing element(s) 205 may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processing element(s) 205 is embodied as an ASIC, FPGA or the like, the processing element(s) may be specifically configured hardware for conducting the operations described herein. Alternatively, as another example, when the processing element(s) 205 is embodied as an executor of software instructions, the instructions may specifically configure the processing element(s) to perform the algorithms and/or operations described herein when the instructions are executed. The processing element(s) 205 may include, among other things, a clock, an arithmetic logic unit (ALU), and logic gates configured to support operation of the processing element(s).

In various embodiments, the imaging system 215 is configured to receive light from a target scene and encode information regarding the spectra of the light received from the target scene in one or more sensor signals that may be processed by the processing element(s) 205 and/or stored in memory 210. In various embodiments, the imaging system 215 is sensitive to light in the ultraviolet (UV), visible, and/or infrared (IR) portions of the electromagnetic spectrum. In an example embodiment, the imaging system 215 is sensitive to light in the wavelength range of 270 to 500 nm.

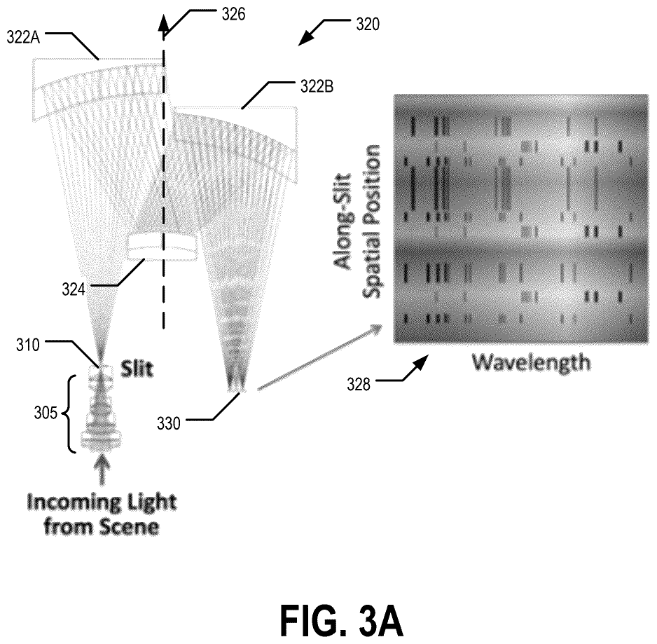

FIG. 3 provides a schematic diagram of an example imaging system 215, according to an example embodiment. In various embodiments, the imaging system 215 includes an objective 305 that is configured to focus light incident thereon onto a slit 310. Light that passes through the slit 310 is provided to a spectrometer assembly 320. In various embodiments, the spectrometer assembly is configured to spectrally disperse the light provided thereto via the slit 310. For example, light of the spectrally dispersed light characterized by wavelengths in a first wavelength range and light of the spectrally dispersed light characterized by wavelength in a second wavelength range, where the first wavelength range and the second wavelength range do not overlap, are spatially separated from one another. In various embodiments, the spectrally dispersed light is directed to a detector 330. The detector 330 measures and/or captures the light incident thereon and generates one or more electronic sensor signals encoding information regarding the light that was incident on the detector 330. The detector 330 provides the one or more sensor signals to an analog-to-digital (A/D) converter 340. The A/D converter 340 is configured to digitize the one or more sensor signals and provide the one or more sensor signals to the processing element(s) 205 and/or memory 210. In various embodiments, the imaging system 215 also includes one or more mirrors 315 (e.g., flat mirrors, fold-flat mirrors, and/or the like) configured for folding the optical path of the imaging system 215. For example, the optical path of the imaging system 215 may be folded in a manner to cause the imaging system to be more compact and/or to prevent stray light from reaching the detector 330.

In various embodiments, the objective 305 is configured to focus light form a target scene onto the slit 310 of the imaging system 215. In various embodiments, the objective 305 comprises a lens assembly. For example, in an example embodiment, the objective 305 comprises an eight-element objective lens assembly consisting of alternating CaF₂ and UV-grade fused SiO₂ elements (e.g., lenses). For example, the objective is configured to provide light without dispersing the light into its constituent colors across the spectral range of interest. In various embodiments, the one or more of the elements (e.g., lenses) of the objective 305 are coated with have an anti-reflection coating. In an example embodiment, the objective 305 further comprises a shroud configured for protecting the objective lens assembly and for thermally stabilizing the objective 305.

In various embodiments, the objective 305 is characterized, at least in part, by a full angle field of view of angle α in a direction corresponding to the narrower dimension of the slit 310. In various embodiments, the angle α is in a range of five thirty degrees. In various embodiments, the angle α is in a range of ten to twenty degrees. For example, in an example embodiment, the angle α is fifteen degrees. For example, if the HSI system 200 is flown on a satellite vehicle 20 in a 500 km altitude orbit, each pixel has a spatial footprint of 0.38 km.

In an example embodiment, the objective 305 is mounted using a two-material mounting scheme. For example, an objective mount used to mount the objective 305 comprises a first material and a second material. In various embodiments, the respective thermal expansion coefficients are selected such that the differential expansion of the first material and the second material compensate for the optical changes of the objective 305 caused by temperature changes thereof. For example, the respective thermal coefficients of the first material and the second material are selected such that the distance between the objective 305 and the slit 310 changes to match the temperature-varying focal length of the objective 305. Thus, independent of the temperature of the objective 305 (e.g., within an operational range) the objective 305 remains focused on the slit 310. In other words, the distance between the objective 305 and the slit 310 is passively adjusted for thermal changes in the focal length of the objective 305 as a result of the selection of the first material and the second material of the objective mount.

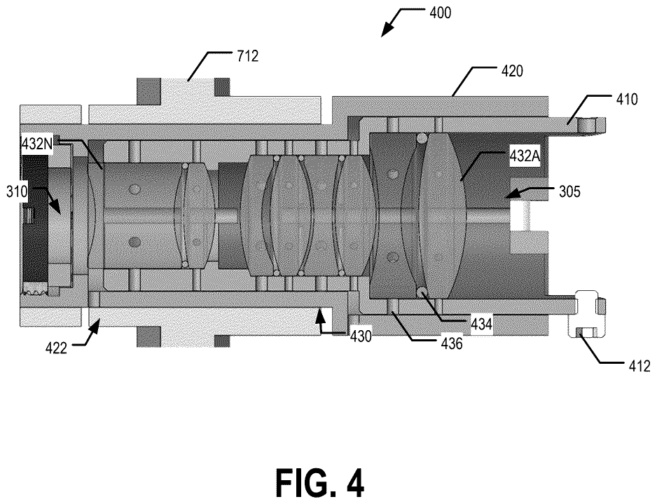

FIG. 4 illustrates a cross-sectional view of an example objective mounting assembly 400 configured for mounting the objective 305, according to an example embodiment. In various embodiments the objective 305 comprises a sequence of optical elements 430, such as lenses 432A-N. In various embodiments, the objective mounting assembly 400 comprises a first mounting tube 410 and a second mounting tube 420. The sequence of optical elements 430 are secured within the first mounting tube 410. For example, the first mounting tube 410 may include radial holes 436 and with each radial hole corresponding to a position of one of the lenses 432. For example, once a lens 432 is positioned within the first mounting tube 410, the lens 432 may be secured into position using glue or adhesive applied through a radial hole 436. In an example embodiment, spacer rings 434 are disposed between adjacent optical elements of the sequence of optical elements 430. For example, a spacer ring 434 disposed between adjacent lenses 432 maintains the distance between the adjacent lenses 432 and maintains the orientation of the lenses with respect to one another.

The first mounting tube 410 is disposed within a second mounting tube 420. The first mounting tube 410 is formed of a first material and the second mounting tube 420 is formed of a second material. In various embodiments, the first material and the second material are selected such that respective thermal expansion coefficients of the first material and the second material result in differential expansion of the first material and the second material that compensates for the optical changes of the objective 305 caused by temperature changes thereof. For example, the respective thermal coefficients of the first material and the second material are selected such that the distance between the objective 305 and the slit 310 changes to match the temperature-varying focal length of the objective 305. In an example embodiment, the first material is aluminum, and the second material is a plastic material.

In various embodiments, the first mounting tube 410 is clamped and/or secured at a first end thereof. For example, the first mounting tube 410 is clamped and/or secured (e.g., to the hyperspectral imaging system and/or a satellite housing the hyperspectral imaging system) at first clamping point 412. The second mounting tube 420 is clamped and/or secured (e.g., to the hyperspectral imaging system and/or a satellite housing the hyperspectral imaging system) at a second clamping point. For example, the second mounting tube 420 may be clamped and/or secured at an end thereof that is proximate the housing wall (e.g., end wall 712) of a vehicle (e.g., satellite) housing the hyperspectral imaging system. The first mounting tube 410 is clamped and/or secured at an opposite end of the objective mounting assembly 400 such that the first mounting tube 410 is able to move with respect the second mounting tube 420. For example, the movement of the first mounting tube 410 with respect to the second mounting tube 420 as the temperature of the objective mounting assembly changes (as a result of the difference in the thermal expansion coefficients thereof) acts to move the objective 305 closer or further from the slit 310 such that the change in the focal length of the objective 305 is compensated for. For example, the movement of the objective 305 as a result of the difference in thermal expansion coefficients of the first mounting tube 410 and the second mounting tube 420 causes the objective 305 to remain focused on the slit 310, even as the temperature changes.

Returning to FIG. 3, in various embodiments, the slit 310 has a narrower dimension and a longer dimension. For example, the narrower dimension d is shown in FIG. 3 and the longer dimension extends into the page in FIG. 3. In various embodiments, narrower dimension d is in a range a few microns to tens of microns. For example, in various embodiments, the narrower dimension d is in a range of ten to fifteen microns. For example, in an example embodiment, the narrower dimension d is thirteen microns. In various embodiments, the longer dimension is in a range of one to ten millimeters. For example, in an example embodiment, the longer dimension is 4.8 millimeters.

In various embodiments, the objective 305 focusses light from a target scene onto the slit 310 and the light that passes through the slit 310 is provided to the spectrometer assembly 320. In various embodiments, the spectrometer assembly 320 comprises an optical bench and a plurality of optical elements that are mechanically coupled to the optical bench. In an example embodiment, the slit 310 is also mechanically coupled to the optical bench. In various embodiments, the optical bench and the plurality of optical elements are formed and/or made of a common material. For example, the common material may be the first material used in the objective mount. In an example embodiment, the first material is aluminum. In an example embodiment, the second material is a plastic material having an engineer thermal expansion coefficient.

The optical elements include one or more optical elements configured to spectrally disperse the light traversing the optical path of the spectrometer assembly 320. For example, in various embodiments, the spectrometer assembly 320 includes a diffractive grating and/or other optical element configured to spectrally disperse the light.

In various embodiments, the spectrometer assembly 320 is an Offner spectrometer. For example, as shown in FIG. 3A, in an example embodiment, the spectrometer assembly 320 includes a first concave spherical mirror 322A configured to receive light provided through the slit 310. The first concave spherical mirror 322A provides the light to a convex spherical diffraction grating 324.

In an example embodiment, the convex spherical diffraction grating 324 is a ruled, blazed grating formed on a convex spherical mirror. In an example embodiment, the convex spherical diffraction grating 324 is formed and/or produced by a replication process, with a master grating first produced by mechanical ruling, from which copies are then replicated onto a coating applied to a pre-fabricated substrate (e.g., the convex spherical mirror). Use of the replication process to form and/or produce the convex spherical diffraction grating 324 enables a wide choice of grating substrate materials and it also allows mounting and alignment registration features to be machined directly into the substrate prior to applying the final replicated ruled, blazed grating. In an example embodiment, the diffraction grating 324 is secured to the optical bench of the spectrometer assembly 320.

In an example embodiment, to optimize sensitivity in the 300-310 nm region, which tends to be relatively dim, the grating blaze was chosen to optimize diffraction efficiency at 300 nm. In an example embodiment, anti-reflection coatings on the lens elements of the objective 305 and mirror coatings (e.g., on the first concave spherical mirror 322A, second concave spherical mirror 322B, and the convex spherical diffraction grating 324) were similarly designed to optimize efficiency at the shorter wavelengths (e.g., less than 400 nm, less than 350 nm, and/or the like).

In various embodiments, the light interacting with the convex spherical diffraction grating 324 is spectrally dispersed and directed toward a second concave spherical mirror 322B. In various embodiments, the first concave spherical mirror 322A and the second concave spherical mirror 322B, and possibly the convex spherical diffraction grating 324, are configured such that the spherical aberrations thereof cancel each other out. For example, the respective geometric distortions introduced into light incident thereon by the first concave spherical mirror 322A and the second concave spherical mirror 322B, and possibly the convex spherical diffraction grating 324 results in a collective geometric distortion of approximately zero. For example, the first concave spherical mirror 322A, convex spherical diffraction grating 324, and the second concave spherical mirror 322B are configured to define a spectrometer assembly optical path that is substantially free of spherical aberration.

In various embodiments, one or more optical elements of the spectrometer assembly 320 are adjustable. For example, in an example embodiment, the tip/tilt and z-translation of one or more of the optical elements of the spectrometer assembly 320 are adjustable. For example, an adjustment mechanism including, for example, one or more adjustment screws, may enable fine tune adjustments of alignment of one or more of the optical elements of the spectrometer assembly 320. For example, in an example embodiment, the alignment of the objective 305 on the slit 310, the alignment of the slit 310 to the first concave spherical mirror 322A, and the alignment of the second concave spherical mirror 322B to the detector 330 may be adjusted via respective adjustment mechanisms.

In various embodiments, each of the adjustment mechanisms includes a locking component configured to lock the position of the respective optical element. For example, the locking component is configured to prevent movement of the adjustment mechanism (e.g., such that the respective alignment is altered thereby) other than during alignment procedures (e.g., during rocket launch, etc.).

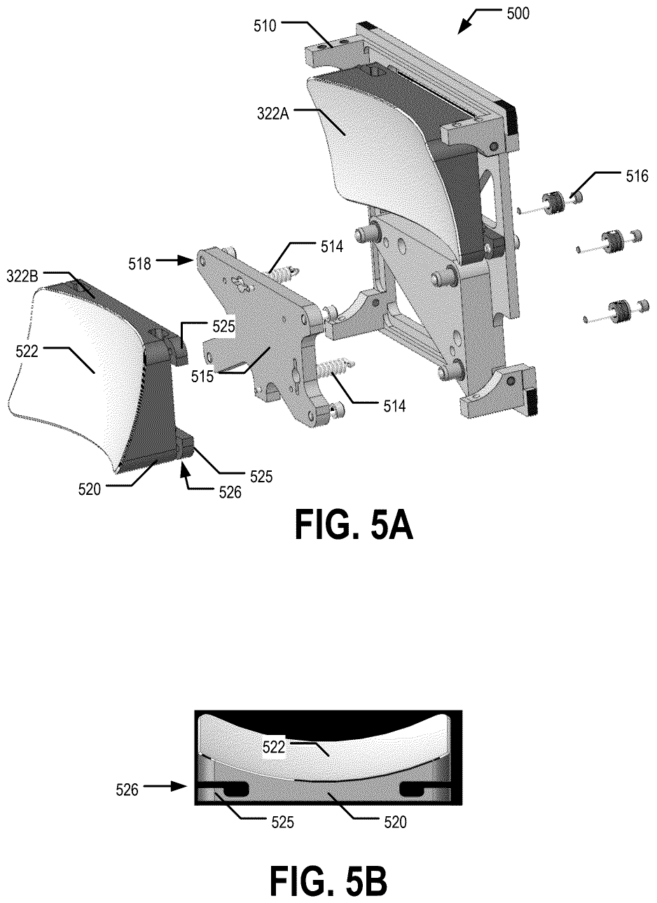

FIGS. 5A and 5B illustrate various views of a mirror mounting assembly 500. In various embodiments, the mirror mounting assembly 500 comprises a frame 510 to which the first mirror 322A and the second mirror 322B are secured. The frame 510 is then secured within the housing of the hyperspectral imaging system. For example, the frame 510 may be part of and/or secured to the optical bench of the spectrometer assembly 320.

In various embodiments a mirror 322 comprises a substrate 520, an optical surface 522 (e.g., a reflective surface), and a plurality of flexures 525. For example, the flexures 525 are integrally formed with the substrate 520. Each of the flexures 525 comprises a mounting hole such that the mirror 322 may be mounted to the frame 510 via the flexures 525. A gap 526 is present between a flexure 525 and the remainder of the substrate 520, such that when mechanical stress is applied to the flexure 525 (as a result of mounting the mirror 322 to the frame 510 via the flexure 525) the flexure 525 is decoupled from the optical surface 522 such that the mechanical stress does not affect the optical properties of the optical surface 522.

In an example embodiment, a mirror is mounted to the frame 510 using a mounting plate 515. In an example embodiment, the mounting plate 515 includes conical slots 518 configured for locking screws 516 to pass therethrough.

In various embodiments, the mirror 322 is mounted using one or more pre-loading springs 514. In various embodiments, the pre-loading spring(s) 514 is configured to pull the mirror 322 toward the frame 510. For example, the pre-loading spring(s) are configured to exert a spring force that generally pulls the mirror 322 toward the frame 510. In various embodiments, the pre-loading spring(s) 514 and the locking screws 516 are configured to assert respective forces on the mirror 322 where both of the pre-loading spring 514 force and the locking screw 516 force are in the same direction. For example, both the pro-loading spring(s) 514 and the locking screws 516 are configured to pull the mirror 322 toward the frame 510. This results in a zero-backlash mounting of the mirror 322 to the frame 510.

Returning to FIG. 3A, in various embodiments, the second concave spherical mirror 322B directs the spectrally dispersed light to the detector 330. In an example embodiment, the detector 330 comprises one or more optical and/or photon sensors that are sensitive within a wavelength range of interest. In an example embodiment, the detector 330 is sensitive to light in the wavelength range of 270 to 500 nm. In an example embodiment, the detector 330 is a charge-coupled device (CCD).

In various embodiments, the detector 330 comprises a two-dimensional array of pixels. For example, as shown in FIG. 3A, a first dimension of the imaging plane 328 of the detector 330 corresponds to spatial direction along the longer dimension of the slit 310 and a second dimension of the imaging plane 328 corresponds to wavelength of the light. For example, each pixel of the detector 330 corresponds to a respective position along (the longer dimension of) the slit 310 and to a wavelength bin. For example, due to the spectral dispersion of the light incident on the imaging plane 328 of the detector 330, each position along the second dimension of the imaging plane corresponds to a wavelength bin. In various embodiments, each wavelength bin is less than five nanometers in width. For example, the spectral resolution of the detector 330 may be less than five nanometers. In an example embodiment, the spectral resolution of the detector 330 is approximately 1.3 nm. In various embodiments, the detector 330 comprises at least 100 spectral channels (e.g., pixels in the second dimension of the imaging plane 328).

In various embodiments, the detector 330 is configured to generate one or more electronic sensor signals (e.g., possibly one per pixel) that encodes information regarding the light detected and/or captured by the respective pixels of the detector 330. For example, light is incident on a respective pixel having a respective first position along the first dimension of the imaging plane 328 and a respective second position along the second dimension of the imaging plane 328. The light incident on the respective pixel is therefore from a position along the slit 310 corresponding to the respective first position along the first dimension and is thus from a particular location within the target scene. The light incident on the respective pixel is within a particular wavelength bin corresponding to the respective second position along the second dimension. Therefore, the intensity of light incident on the respective pixel is indicative of the intensity of light in the particular wavelength bin emanating from

In an example embodiment, the optical path of the imaging system 215 is folded (e.g., via mirror 315) such that the detector 330 faces perpendicular to the main axis 326 of the spectrometer assembly 320. For example, the main axis 326 may be the main Offner axis in example embodiments where the spectrometer assembly 320 is an Offner spectrometer.

In various embodiments, a baffle assembly 350 is positioned about the detector 330 to prevent stray light from being incident on the imaging plane 328 of the detector 330. In various embodiments, the baffle assembly 350 houses at least a portion of a calibration system configured for calibrating the detector 330. For example, in an example embodiment, the calibration system includes a plurality (e.g., four) calibration system illumination sources 360. The calibration system illumination sources 360 may be mounted to the baffle assembly 350 such that the calibration system illumination sources 360 do not move with respect to the detector 330.

In an example embodiment, the calibration system illumination sources 360 are configured to uniformly illuminate the detector 330 at a selected brightness. For example, by uniformly illuminating the detector at a selected brightness the response of each pixel may be determined and differences in the response of each pixel to the uniform illumination are determined. This enables any non-uniformity in the response of the detectors to be removed from the HSI data through calibration.

In an example embodiment, the calibration system illumination sources 360 are light emitting diodes (LEDs). This enables the calibration system to have small power requirements and allows for control over the brightness of the uniform illumination field generated by the calibration system illumination sources 360.

In various embodiments, the detector 330 is maintained at low temperature (e.g., below 0° C.) . In various embodiments, the temperature management of the detector 330 is performed passively. For example, the detector 330 is mounted within the hyperspectral imaging system such that the detector 330 is in thermal communication with the housing of the hyperspectral imaging system 100 and/or the vehicle (e.g., satellite) housing the hyperspectral imaging system 100. For example, the detector 330 may be mounted within the housing of the hyperspectral imaging system 100 using a mounting frame that is thermally conductive. In an example embodiment, the mounting frame used to mount the detector 330 within the housing of the hyperspectral imaging system 100 comprises the first material.

The thermal communication between the hyperspectral imaging system 100 and/or the vehicle (e.g., satellite) housing the hyperspectral imaging system 100 enables heat generated by the operation of the detector to be efficiently conducted away from the detector 330 such that the detector is maintained at low temperature. For example, the housing of the hyperspectral imaging system 100 and/or the vehicle (e.g., satellite) housing the hyperspectral imaging system 100 may act as a heat sink for heat generated by the operation of the detector 330 and provide a surface area from which the heat may be radiated away from the hyperspectral imaging system 100.

In some embodiments, a surface treatment is applied to the surface of a vehicle housing the hyperspectral imaging system 100. In an example embodiment, the vehicle housing the hyperspectral imaging system 100 is a satellite that also houses components (e.g., batteries, processing components, and/or the like) that need to be maintained at a higher temperature than the detector 330. For example, operation of the hyperspectral imaging system 100 and the satellite housing the hyperspectral imaging system 100 may be optimal when the hyperspectral imaging system 100 is maintained at low temperatures (e.g., below 0° C.) and the remainder of the satellite is maintained at a moderate temperature (e.g., above 0° C.) . In such embodiments, different surface treatments may be applied to different portions of the surface of the satellite. For example, a first surface treatment may be applied to a portion of the surface of the satellite that houses the hyperspectral imaging system 100 and a second surface treatment may be applied to a portion of the surface of the satellite that houses other components (e.g., does not house the hyperspectral imaging system 100). For example, in an example embodiment, a first surface treatment is applied to the surface of a first portion of the satellite that houses the hyperspectral imaging system 100. The first surface treatment is configured to prevent heating of the first portion of the satellite due to light being incident thereon. A second surface treatment is applied to the surface of a second portion of the satellite that houses components of the satellite other than the hyperspectral imaging system 100. The second surface treatment is configured to extract heat from light incident thereon to (passively) heat the second portion of the satellite.

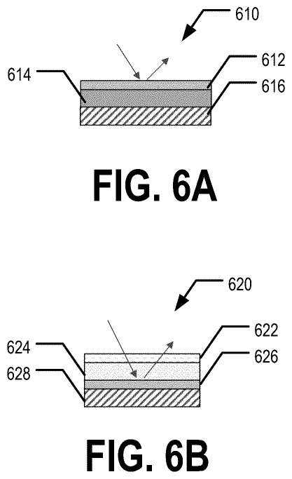

FIG. 6A illustrates a cross-sectional diagram of an example first surface treatment 610 that may be applied to a first portion of the surface of the satellite that houses the hyperspectral imaging system 100. In the illustrated embodiment, the first surface treatment 610 is a first surface mirror tape. For example, the first surface treatment 610 comprises a reflective layer 612, a backing layer 614, and an adhesive layer 616. Thus, when light is incident on the first surface treatment 610 (on the first portion of the surface of the satellite), the light reflects off the surface and does not heat the first portion of the satellite housing the hyperspectral imaging system 100. The adhesive layer 616 is configured for adhering the first surface treatment 610 to the surface of the satellite.

FIG. 6B illustrates a cross-sectional diagram of an example second surface treatment 620 that may be applied to a second portion of the surface of the satellite that houses the hyperspectral imaging system 100. In the illustrated embodiment, the second surface treatment 620 is a second surface mirror tape. For example, the second surface treatment 620 comprises a transparent enclosing layer 622, a heat absorption layer 624, a reflective layer 626, and an adhesive layer 628. The transparent enclosing layer 622 and the heat absorption layer 624 enact a greenhouse effect to extract heat from light incident thereon. For example, the heat absorption layer 624 may comprise a material that does radiate efficiently in the infrared. The reflective layer 626 reflects the light incident thereon so the light travels through the heat absorption layer 624 a second time. The adhesive layer 628 is configured for adhering the second surface treatment to the surface of the satellite. Thus, when light is incident on the second surface treatment 620 (on the second portion of the surface of the satellite), the light acts to heat the second portion of the satellite.

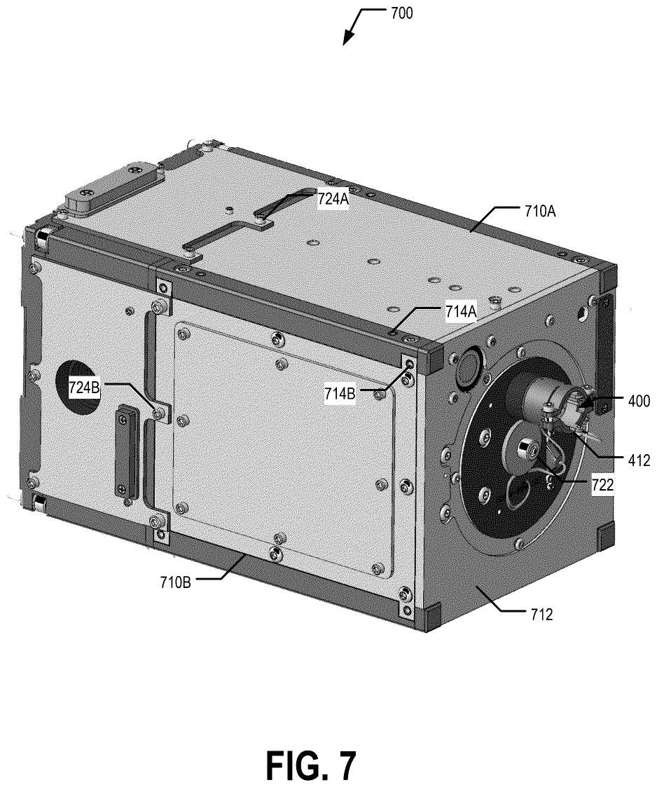

FIG. 7 illustrates a perspective view of a housing 700 of a hyperspectral imaging system 100, according to an example embodiment. In the illustrated embodiment, the housing 700 comprises a plurality of side walls 710 (e.g., 710A, 710B), and a plurality of end walls 712. In various embodiments, the side walls 710 and the end walls 712 are secured to one another to form a generally rectangular prism. In various embodiment, the side walls 710 and the end walls 712 are secured to one another using mechanical fasteners. In the illustrated embodiment, in additional to mechanical fasteners, pinned joints 714 (e.g., 714A, 714B) are used to secure the sidewalls 710 and the end walls 712 to one another. In an example embodiment a pinned joint 714 comprises holes that are aligned with one another that are drilled through the respective walls 710, 712 with a dowel pin inserted and/or secured therein. For example, the dowel pin may be adhered within the pre-drilled holes.

In an example embodiment, some of the mechanical fasteners used to secure portions of the housing to one another are also used to secure optical elements of the hyperspectral imaging system within the housing 700. For example, mechanical fastener 722 may, at least in part, mechanically secure the diffraction grating 324 within the housing 700. In another example, mechanical fasteners 724 may, at least in part, mechanically secure the mirror mounting assembly 500 within the housing 700. This enables the structural rigidity of the housing 700 to aid in maintaining alignment between the diffraction grating 324 and the mirrors 322A, 322B secured to the mirror mounting assembly 500, in an example embodiment.

In various embodiments, the side walls 710 and the end walls 712 of the housing 700 are formed of the first material (e.g., the common material used for the optical elements and optical bench of the hyperspectral imaging system 100).

In various embodiments, at least a portion of the hyperspectral imaging system 100 comprises and/or is wrapped in ballast material. The orbital lifetime of a satellite is proportional to the ratio of the mass of the satellite to the surface area of the satellite. Therefore, in various embodiments, to increase the mass to surface area ratio of the satellite, a ballast is added to the housing 700 of the hyperspectral imaging system 100. For example, in an example embodiment, plates and/or panels of a dense material are applied and/or attached to surfaces (e.g., side walls 710 and/or end walls 712) of the housing 700 of the hyperspectral imaging system 100. In various embodiments, the dense material is configured to burn up quickly and efficiently when the satellite re-enters the Earth's atmosphere. For example, in an example embodiment, the dense material is a tungsten polymer formed by embedding tungsten powder in a polymer.

### VI. Example Operation of HSI System

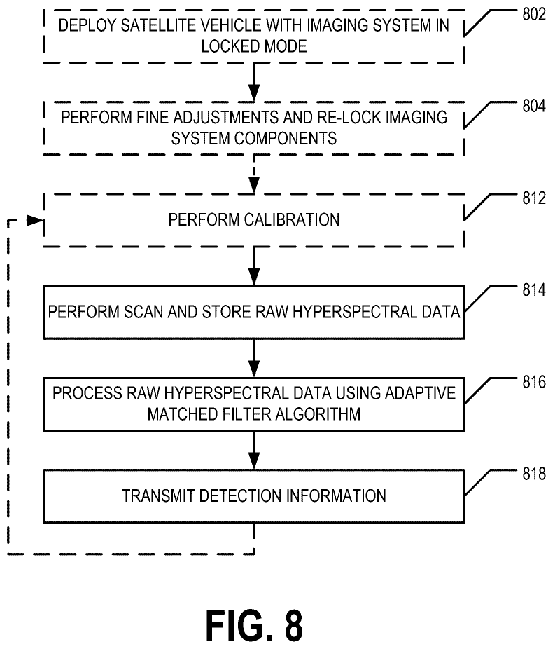

FIG. 8 provides a flowchart illustrating various steps of capturing and providing information regarding the presence and/or abundance of trace gases using an HSI system 200. Starting at step 802, a satellite vehicle 20 having an HSI system 200 onboard is deployed. For example, the satellite vehicle 20 having an HSI system 200 onboard is launched into an orbit, such as a low Earth orbit, and/or the like. During the deployment, the locking components of the imaging system 215 are in locked mode. For example, one or more locking components are used to prevent undesired change of the alignment components of the optical elements of the imaging system 215 that have alignment capabilities.

At step 804, once the satellite vehicle 20 with the HSI system 200 onboard is in orbit, one or more fine adjustments of the alignment of optical elements of the imaging system 215 are performed. Once the adjustments of the alignment of the optical elements of the imaging system 215 are made, the locking components are re-locked such that the alignment of the optical elements is secured.

At step 812, a calibration may be performed. For example, operation of the calibration system illumination sources 360 may be controlled to cause the calibration system illumination sources 360 to generate a uniform light field of a selected brightness and the response of each of the pixels of the detector 330 may be determined. One or more calibration corrections are determined based on differences and/or non-uniformities in the responses of the pixels of the detector 330. The one or more calibration corrections may be stored in memory 210.

At step 814, a scan is performed and the raw hyperspectral datacube is stored in memory 210. For example, the satellite vehicle 20 is navigated such that the objective 305 is pointed at a first position of a target scene. Light from the first position of the target scene enters the objective 305, is focused onto the slit 310, and spectrally dispersed by the spectrometer assembly 320. The spectrally dispersed light is incident on the detector 330 and each pixel captures a respective intensity of a respective wavelength bin for a respective position along the slit 310. One or more sensor signals are generated by the detector 330 and provided to the processing element(s) 205 via the A/D converter 340. The position of the satellite vehicle 20 is then modified such that light from a second position of the target scene is incident on the objective 305. This process is repeated until light from each position of the target scene has been captured by the detector 330 and encoded into the respective sensor signal(s) to form an HSI datacube have two spatial dimensions (e.g., corresponding to the spatial dimensions of the target scene) and a third dimension that indicates the intensity of light in a respective wavelength bin emanating from a respective x, y position of the target scene.

At step 816, the raw hyperspectral data (e.g., the HSI datacube) is processed to generate detection maps for one or more trace gases of interest. For example, the memory 210 stores a plurality of spectral data objects that each encode the spectral fingerprint of a respective trace gas of interest. The spectral data objects may be compared to spectral data for each x, y position of the target scene to determine the presence and/or abundance of respective trace gases of interest at the respective x, y position of the target scene. For example, the processing element(s) 205 may use an adaptive matched filter algorithm (e.g., using the spectral data objects) to determine the presence and/or abundance of respective trace gases of interest at respective x, y positions of the target scene. The individual presence and/or abundance determinations for a particular trace gas of interest may then be combined to form a detection map for the particular trace gas of interest. For example, a detection map corresponding to a particular trace gas of interest is a map of the target scene that indicates the presence and/or abundance of the particular trace gas at the various x, y positions of the target scene. In an example embodiment, a detection map has a size that is on the order of 1 Megabyte.

In various embodiments, various other information is determined and/or generated based on the raw hyperspectral data (e.g., the HSI datacube). For example, in an example embodiment, a Mahalanobis distance image is generated that indicates, for each x, y position of the target scene, a Mahalanobis distance. In various embodiments, approximation techniques are used to reduce the processing time required to generate the Mahalanobis distance image from several hours to a few minutes. For example, in various embodiments, a sparce matrix transform is used during the generation of the Mahalanobis distance image. In an example, another approximation technique used in the generation of the Mahalanobis distance image includes estimating a covariance matrix using a sub-sample of all of the pixels of the HSI datacube.

In another example, metadata regarding the detection maps may be determined and/or generated such as a date and time at which the raw hyperspectral data was captured, the location and/or boundary of the target scene, a temperature of the detector 330 during the scan, and/or other information regarding the operation of the HSI system 200 during the capturing of the raw hyperspectral data (e.g., the HSI datacube).

At step 818, the results of processing the raw hyperspectral data (e.g., the HSI datacube) are transmitted for receipt by the ground-based system 10. For example, the communications interface 220 transmits the detection maps and/or other information generated and/or determined by processing the raw hyperspectral data (e.g., the HSI datacube).

The ground-based system 10 may receive the results of processing the raw hyperspectral data (e.g., the HSI data cube). In an example embodiment, the ground-based system 10 combines a detection map with the Mahalanobis distance image to generate a more accurate detection map for the target scene. In various embodiments, the ground-based system 10 may provide (e.g., transmit, display, and/or the like) one or more detection maps via the user interface 915 and/or the communications interface 920.

The HSI system 200 may then be used to capture hyperspectral data from one or more other target scenes and/or the same target scene at another point in time.

### V. Example Ground-Based System

The ground-based system 10 of an example embodiment may be embodied by or associated with a variety of computing entities or devices such as a server, desktop computer, laptop, tablet, smartphone, and/or the like. As shown in FIG. 9, the ground-based system 10 may comprise one or more processors 905, memory 910, a user interface 915, a communications interface 920, and/or other components configured to perform various operations, procedures, functions or the like described herein.

In some embodiments, the processor 905 (and/or co-processors or any other processing circuitry assisting or otherwise associated with the processor) may be in communication with the memory 910 via a bus for passing information among components of the ground-based system 10. The memory 910 may include a non-transitory memory device. The memory 910 may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the ground-based system 10 to carry out various functions in accordance with an example embodiment of the present invention. For example, the memory device could be configured to buffer input data for processing by the processor. Additionally or alternatively, the memory device could be configured to store instructions for execution by the processor.

As described above, the ground-based system 10 may be embodied by a computing device and/or computing entity. However, in some embodiments, the ground-based system 10 may be embodied as a chip or chip set. In other words, the ground-based system 10 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The ground-based system 10 may therefore, in some cases, be configured to implement an embodiment of the present invention on a single chip or as a single “system on a chip.” As such, in some cases, a chip or chipset may constitute means for performing one or more operations for providing the functionalities described herein.

The processor 905 may be embodied in a number of different ways. For example, the processor 905 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 905 may include one or more processing cores configured to perform independently. A multi-core processor may enable multiprocessing within a single physical package. Additionally or alternatively, the processor 905 may include one or more processors configured in tandem via the bus to enable independent execution of instructions, pipelining and/or multithreading.

In an example embodiment, the processor 905 may be configured to execute instructions stored in the memory 910 or otherwise accessible to the processor. Alternatively or additionally, the processor 905 may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the ground-based system 10 may include a user interface 915 that may, in turn, be in communication with the processor 905 to provide output to the user, such as one or more detection maps corresponding to respective trace gases of interest, and/or the like, and, in some embodiments, to receive an indication of a user input. As such, the user interface may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor 905 may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 905 (e.g., memory 910 and/or the like).

The ground-based system 10 may further include a communications interface 920. The communications interface 920 may be any means such as a device or circuitry embodied in either hardware or a combination of hardware and software that is configured to receive and/or transmit data from/to a network and/or any other device or module in communication with the ground-based system 10. In this regard, the communications interface 920 may include, for example, an antenna (or multiple antennas) and supporting hardware and/or software for enabling communications with a wireless communication network. Additionally or alternatively, the communications interface may include the circuitry for interacting with the antenna(s) to cause transmission of signals via the antenna(s) or to handle receipt of signals received via the antenna(s). In some environments, the communications interface may alternatively or also support wired communication. As such, for example, the communications interface 920 may include a communication modem and/or other hardware/software for supporting communication via cable, digital subscriber line (DSL), universal serial bus (USB) or other mechanisms.

### VI. Apparatus, Methods, and Computer Program Products

As described above, FIG. 8 illustrates a flowchart of which one or more steps thereof may be performed by an HSI system 200, in various embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 210 of an HSI system 200 employing an example embodiment and executed by the processing element(s) 205 of the HSI system 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, simplifications, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A hyperspectral imaging system, the system comprising:
an objective;
a slit, the objective configured to focus light on the slit;
a spectrometer assembly configured to spectrally disperse the light received via the slit;
a detector, wherein the spectrometer assembly focuses the spectrally dispersed light onto the detector and the detector captures hyperspectral imaging data; and
a memory configured to store the hyperspectral imaging data,
wherein the spectrometer assembly comprises an optical bench and a plurality of optical elements that are each formed of a common material such that the optical bench and the plurality of optical elements have a same thermal coefficient of expansion.

2. The system of claim 1, further comprising an objective mounting assembly configured for mounting the objective to the hyperspectral imaging system, the objective mounting assembly comprising a first mounting tube and a second mounting tube, a sequence of lenses of the objective are secured within the first mounting tube and the first mounting tube is disposed at least partially within the second mounting tube, wherein the first mounting tube is formed of a first material having a first thermal coefficient of expansion and the second mounting tube is formed of a second material having a second thermal coefficient of expansion, and wherein the first thermal coefficient of expansion and the second thermal coefficient of expansion are selected such that when the hyperspectral imaging system experiences a change in temperature, a change in distance between the objective and the slit due to the difference in the first thermal coefficient of expansion and the second thermal coefficient of expansion is substantially equal to a change in a focal distance of the objective as a result of the change in temperature.

3. The system of claim 1, wherein the plurality of optical elements comprises a first mirror and a second mirror and the optical bench comprises or has secured thereto a mirror mounting assembly, the first mirror and the second mirror are mounted to the mirror mounting assembly with zero backlash.

4. The system of claim 3, wherein at least one of the first mirror or the second mirror are mounted to the mirror mounting assembly with one or more pre-loading springs and one or more locking screws, the one or more pre-loading springs and the one or more locking screws configured to exert respective forces on the at least one of the first mirror or the second mirror in a common direction.

5. The system of claim 3, wherein at least one of the first mirror or the second mirror comprises a plurality of flexures configured for mounting the at least one of the first mirror or the second mirror to the mirror mounting assembly and the plurality of flexures is configured to decouple an optical surface of the at least one of the first mirror or the second mirror from mechanical stress applied to the mirror by the mounting the at least one of the first mirror or the second mirror to the mirror mounting assembly via the plurality of flexures.

6. The system of claim 1, wherein the detector is in thermal communication with a housing of the hyperspectral imaging system to cause, at least in part, passive thermal management of the detector.

7. The system of claim 1, further comprising a baffle configured to block stray light from reaching the detector, and a plurality of calibration system illumination sources configured to collectively uniformly illuminate the detector for use in calibrating the detector are secured to the baffle.

8. The system of claim 1, wherein the spectrometer assembly is an Offner spectrometer assembly.

9. The system of claim 8, wherein the plurality of optical elements comprises a first concave spherical mirror, a convex spherical diffraction grating, and a second concave spherical mirror, the first concave spherical mirror configured to refocus the light received via the slit onto the convex spherical diffraction grating, the convex spherical diffraction grating configured to spectrally disperse the light focused thereon, the second concave spherical mirror configured to refocus the spectrally dispersed light onto an imaging plane of the detector, and wherein the first concave spherical mirror, convex spherical diffraction grating, and the second concave spherical mirror are configured to define, at least a spectrometer assembly optical path that is substantially free of spherical aberration.

10. The system of claim 9, wherein the convex spherical diffraction grating is a ruled, blazed grating.

11. The system of claim 8, further comprising a fold flat mirror and the fold flat mirror is disposed along an optical path between the second concave spherical mirror and the detector and the imaging plane of the detector faces perpendicular to a main Offner axis of the spectrometer assembly.

12. The system of claim 8, comprising one or more alignment adjustment components, a first alignment adjustment components configured to control alignment of the objective with respect to the slit, a second alignment adjustment component configured to control alignment of the slit with respect to the first concave spherical mirror, and a third alignment adjustment component configured to control alignment of the second concave spherical mirror with respect to the detector.

13. The system of claim 12, wherein each alignment adjustment component comprises a locking component configured to lock a respective optical element in a respective position.

14. The system of claim 1, further comprising one or more processing elements, the one or more processing elements configured to process the hyperspectral imaging data to generate one or more detection maps using an adaptive matched filter algorithm.

15. The system of claim 14, wherein the memory stores a plurality of spectral data objects, each spectral data object configured to represent a multi-wavelength spectrum of a respective gas species of interest and the plurality of spectral data objects are configured for use in generating the one or more detection maps.

16. The system of claim 15, wherein the memory stores executable-instructions configured to, when executed by the one or more processing elements, cause the one or more processing elements to compare the multi-wavelength spectrum of each of each of a plurality of gas species of interest to at least a portion of the hyperspectral imaging data to generate the one or more detection maps.

17. The system of claim 14, wherein the memory stores executable-instructions configured to, when executed by the one or more processing elements, cause the one or more processing elements to generate a Mahalanobis distance image based at least in part on the hyperspectral imaging data using a sparce matrix transform.

18. The system of claim 17, further comprising a communication interface, the communication interface configured to transmit the one or more detection maps and the Mahalanobis distance image for receipt by a ground-based system.

19. The system of claim 1, wherein the hyperspectral imaging system has a volume that is at most two CubeSat units.

20. The system of claim 1, wherein at least one of:
(a) the common material is aluminum,
(b) the objective comprises a lens assembly comprising a plurality of alternating CaF₂ and ultraviolet (UV)-grade fused SiO₂ lens elements,
(c) the detector comprises at least 100 spectral channels, or
(d) a spectral resolution of each channel of the detector is 5 nm or less.
